(19) United States
(12) Patent Application Publication
(10) Pub. No.: US 2009/0045179 A1
(43) Pub. Date: Feb. 19, 2009

(54) Method and system for cutting solid materials using short pulsed laser

(76) Inventor: Ellen Marie Kosik Williams, Painted Post, NY (US)

Correspondence Address: CORNING INCORPORATED, SP-TI-3-1, CORNING, NY, 14831, US

(21) Appl. No.: 11/893,185

(22) Filed: Aug. 15, 2007

(51) Int. Cl. B23K 26/38; B23K 26/06

(52) U.S. Cl. 219/121.72; 219/121.67

(57) ABSTRACT

A method of cutting a solid material using a pulsed laser includes providing a pulsed laser beam, selecting a target point in the solid material, focusing the pulsed laser beam on the solid material such that at the target point in the solid material the pulsed laser beam has at least the minimum energy density required to ablate the solid material, and effecting relative motion of the pulsed laser beam with respect to the solid material such that the pulsed laser beam traces a first path to form a scribe line in the solid material and then a second path to form a second scribe line in the solid material, wherein the first path and the second path are essentially parallel and the first and second scribe lines overlap to form a single cut line in the solid material.

### TECHNICAL FIELD

The invention relates generally to laser processing of solid materials which have a large bandgap and/or are transparent. The term “transparent,” as used herein, means that the solid material is transmissive to electromagnetic radiation of given frequencies, which may or may not be in the visible range.

### BACKGROUND

Precision cutting of large bandgap and/or transparent solid materials can be challenging, particularly if the desired cut has a high aspect ratio and/or is curvilinear. Scribe and break techniques can be used to make linear cuts in solid materials, but not with high precision. For crystalline materials, scribe and break techniques are limited to cuts along one of the crystallographic planes of the material. Arbitrary curvilinear cuts are generally not possible with scribe and break techniques. Laser cutting techniques can be used to make linear and curvilinear cuts in solid materials with high precision. However, there are challenges in using lasers to make cuts with high aspect ratio in large bandgap and/or transparent solid materials.

When lasers are used in ablation of large bandgap and/or transparent solid materials, it is typically necessary to focus the laser beam tightly to achieve the energy density required to reach the ablation threshold and remove material. This tightly focused laser beam results in a thin scribe line in the material. For a cut having a high aspect ratio, subsequent multiple passes of the laser beam along the scribe line may be needed to reach the desired depth. As the tightly focused laser beam is stepped more deeply into the material, the laser beam begins to focus through some of the material along the sides of the cut. Consequently, the material along the sides of the cut aberrates and distorts the focus of the beam. After some depth, the focus of the beam may be such that it is no longer strong enough to remove material. Although it is possible to overcome beam aberration by using a more loosely focused beam, the looser focused beam might not have the energy density required to overcome the ablation threshold and remove material. Using laser beam with higher energy density could presumably achieve ablation notwithstanding the beam aberration and distortion, but that could also result in ablation of area not intended for removal.

### SUMMARY

In one aspect, the invention relates to a method of cutting a solid material using a pulsed laser which comprises providing a pulsed laser beam, selecting a target point in the solid material, focusing the pulsed laser beam on the solid material such that at the target point in the solid material the pulsed laser beam has at least the minimum energy density required to ablate the solid material, and effecting relative motion of the pulsed laser beam with respect to the solid material such that the pulsed laser beam traces a first path to form a first scribe line in the solid material and then traces a second path to form a second scribe line in the solid material, wherein the first path and the second path are essentially parallel and the first and second scribe lines partially or fully overlap to form a single cut line in the solid material.

The method may further include moving the target point deeper into the solid material and repeating focusing the pulsed laser beam and effecting relative motion of the pulsed laser beam to deepen the single cut line. The method may include repeating moving the target point, focusing the pulsed laser beam, and effecting relative motion of the pulsed laser beam until the single cut line reaches a desired depth in the solid material. The desired depth may be equal to a thickness of the solid material. In one embodiment, the desired depth is greater than 200 μm. In one embodiment, the ratio of the desired depth to the kerf width of the single cut line is 5 or greater.

In one embodiment, the essentially parallel paths traced by the pulsed laser beam are linear. In another embodiment, the essentially parallel paths traced by the pulsed laser beam are curvilinear.

In one embodiment, the pulse duration of the pulsed laser beam is in a range from 10 femtoseconds to 200 picoseconds.

In one embodiment, the solid material is a large bandgap material. In another example, the solid material is a transparent material.

In another aspect, the invention relates to a system for cutting a solid material which includes a laser device that generates a pulsed laser beam, a support for mounting solid material thereon, and a mechanism that effects a relative motion of the pulsed laser beam relative to the solid material such that the pulsed laser beam traces a first path to form a first scribe line in the solid material and then traces a second path to form a second scribe line in the solid material, wherein the first path and the second path are essentially parallel and the first and second scribe lines partially or fully overlap to form a single cut line in the solid material.

The system may include an optical system which focuses the pulsed laser beam such that at a target point in the solid material the pulsed laser beam has at least the minimum energy density required to ablate the solid material.

The system may include a control apparatus for controlling operation of the mechanism that effects relative motion of the pulsed laser beam relative to the solid material.

The pulsed laser may generate pulses with a duration in a range from 10 femtoseconds to 200 picoseconds.

Other features and advantages of the invention will be apparent from the following description and the appended claims.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1 is a schematic of a system for cutting a solid material using a pulsed laser beam.

FIGS. 2A-2B illustrate a method of cutting a solid material by tracing two essentially parallel paths with a pulsed laser beam.

FIG. 2C is a perspective view of a solid material having a single cut line formed according to the method illustrated in FIGS. 2A-2B.

FIG. 2D illustrates a method of cutting a solid material by tracing two curvilinear paths with a pulsed laser beam.

FIGS. 3A-3B illustrate deepening of a single cut line formed in a solid material according to the method illustrated in FIGS. 2A-2B.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

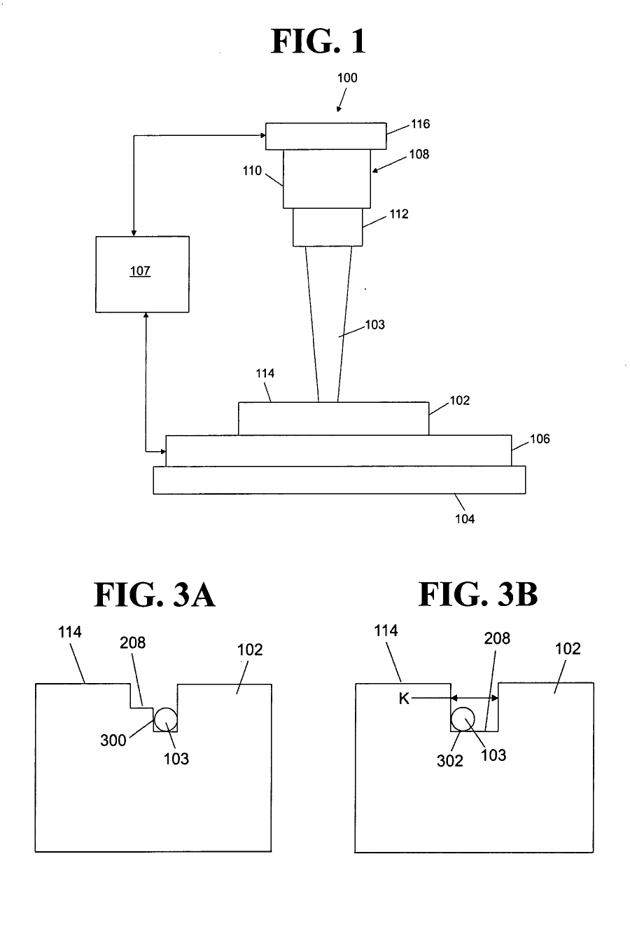

FIG. 1 illustrates an exemplary system 100 for cutting a solid material 102 using a focused pulsed laser beam 103. In one embodiment, the solid material 102 is selected from large bandgap materials, transparent materials, and large bandgap and transparent materials. The large bandgap and/or transparent materials may be selected from crystals, semiconductors, glasses, ceramics, organics, and plastics. The solid material 102 may also be a metal. The solid material 102 may be composed of a single material or of multiple materials which together function to provide a large bandgap and/or transparent material. Examples of large bandgap and/or transparent materials which may be used as the solid material 102 include sapphire (Al₂O₃), diamond, galium nitride, silicon carbide, zinc selenide, silicon, silicon nitride, aluminum nitride, gallium nitride on sapphire, and glass (e.g., fused quartz or silica).

The system 100 includes a support 104 on which the solid material 102 is mounted. The support 104 may include a one-, two-, or three-dimensional translation stage 106 arranged to impart a translational motion to the solid material 102, thereby allowing the solid material 102 to move relative to the focused pulsed laser beam 103. The translation stage 106 may be operated manually or may receive commands from a control apparatus 107. Where used, the control apparatus 107 includes the necessary processing circuitry to communicate with the translation stage 106 as needed.

A laser assembly 108 is mounted above, or in opposing relation to, the support 104. The laser assembly 108 includes a laser device 110, which generates a pulsed laser beam, and an optical system 112, which focuses the pulsed laser beam above, at, or below the surface 114 of the solid material 102. The optical system 112 may be a separate unit or may be integrated with the laser device 110. The optical system 112 may include one or more lenses and/or other optical elements for focusing a beam as is well known in the art. The laser device 110 is preferably a short pulsed laser device. In one embodiment, the short pulsed laser device is an ultra-short pulsed laser device, providing laser pulses with duration in the picosecond (10⁻¹² s) and/or femtosecond (10⁻¹⁵ s) regime. In one embodiment, the ultra-short pulsed laser device generates a pulsed laser with pulse duration in a range from 10 femtoseconds (fs) to 200 picoseconds (ps). The pulsed laser may generate pulses at wavelengths in the ultraviolet, visible, or infrared range. Examples of pulse repetition rates are from 1 Hz to 10 MHz. Large bandgap and transparent materials are more efficiently processed with short pulsed lasers as opposed to, for example, continuous wave or long pulsed lasers. The short pulses produced by short pulsed lasers have very high energy densities needed for breaking molecular bonds in large bandgap materials. They also interact nonlinearly with the material, leading to multi-photon absorption that bridges large bandgaps and circumvents the need to operate at an absorptive laser wavelength. Non-absorbing, short pulses also have decreased thermal effects in the material, which allows for cleaner, more precise cuts and minimized heat affected zone.

The laser assembly 108 may be coupled to a one-, two-, or three-dimensional translation stage 116 such that it is movable relative to the solid material 102. The translation stage 116 may be controlled manually or may receive commands from the control apparatus 107 in the same manner described for the translation stage 106. Although not shown, the system 100 may include a sensor or other means for monitoring the depth of a cut made in the solid material using the laser device 110. Where the system 100 is automated, the depth monitoring means may communicate with the control apparatus 107, whereby the control apparatus 107 uses information received from the depth monitoring means to control the relative spacing between the laser assembly 108, or focal plane of the pulsed laser beam 103, and the solid material 102. Although the laser device 110 is shown directly above the solid material 102, this need not be the case. For example, the laser device 110 may be located elsewhere and appropriate optical elements such as optical fibers, lenses, and mirrors can be used to direct the output of the laser device 110 to the solid material 102. Optical scanning techniques can also be used in lieu of translation stages 106, 116 to move the pulsed laser beam 103 relative to the solid material 102.

A method of cutting the solid material 102 includes operating the laser device 110 to generate a pulsed laser beam and directing the pulsed laser beam to the surface 1 14 of the solid material 102. The method includes focusing the pulsed laser beam 103, for example, using a focusing lens in the optical system 112. The energy density at the focal plane of the pulsed laser beam 103 is at least equal to the minimum energy density required to ablate the solid material 102. This minimum energy density is dependent on the type of solid material 102 and the duration of the laser pulse. The position of the focal plane of the pulsed laser beam 103 relative to the solid material 102 is such that at a target point in the solid material 102 the pulsed laser beam has at least the minimum energy density required to ablate the solid material 102. Initially, the target point is near the surface 114 of the solid material 102. For making deeper cuts, the target point is located deeper in the solid material 102. To achieve the desired energy density at the target point, the focus of the pulsed laser beam 103 may have to be tight. In general, a focus is considered to be tight if the beam spot size at the focal plane is less than 100 μm, or if focal length versus diameter of the focusing lens is less than 50.

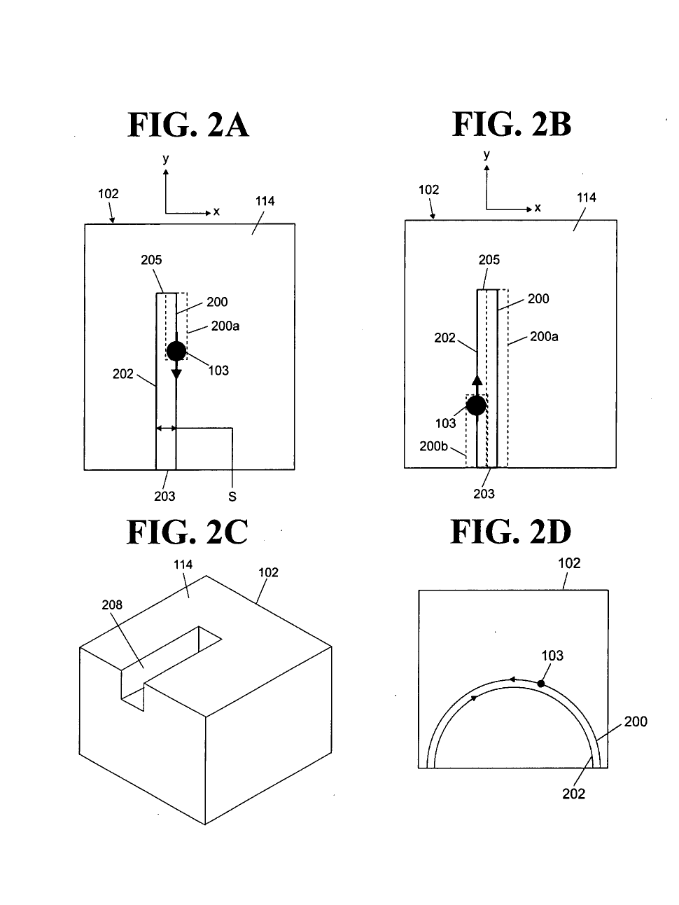

FIGS. 2A and 2B illustrate how a single cut line is formed in the solid material 102. The focused pulsed laser beam 103 traces a first path 200 (FIG. 2A) and then a second path 202 (FIG. 2B) on the surface 114 (x-y plane) of the solid material 102, where the first and second paths 200, 202 are essentially parallel. By “essentially parallel,” it is meant that the paths 200, 202 do not cross in a region in which the single cut line is formed or will be formed. The first and second paths 200, 202 are traced separately and conform to the profile of the desired single cut line. The trace of the focused laser beam 103 may form a closed loop as it moves from the first path 200 to the second path 202 along connecting path 203, and then back to the first path 200 along connecting path 205. The trace along the first path 200 results in a first scribe line 200a in the solid material 102 (FIGS. 2A, 2B). The trace along the second path 202 results in a second scribe line 200b in the solid material 102 (FIG. 2B). The spacing (S in FIG. 2A) between the first path 200 and the second path 202 is such that the first and second scribe lines 200a, 200b overlap (fully or partially) or merge to form a single cut line, as shown at 208 in FIG. 2C. Typically, this requires the spacing between the first and second paths 200, 202 to be on the order of the beam spot size at the focal plane of the focused pulsed laser beam 103. In general, the pulsed laser beam 103 can trace two or more essentially parallel paths, with the spacing between adjacent essentially parallel paths being such that the individual scribe lines made during each trace overlap or merge to form a single cut line. The first and second paths 200, 202 (and additional essentially parallel paths if used) can be linear or curvilinear and would conform to the desired cut line. FIG. 2D shows a trace pattern where the first and second paths 200, 202 are curvilinear. Motion of the focused pulsed laser beam 103 relative to the solid material 102 to trace the essentially parallel paths and form the scribe lines may be performed manually or automatically through the control apparatus (107 in FIG. 1). The pulsed laser beam 103 may be stationary while the solid material 102 moves, or vice versa.

The single cut line (208 in FIG. 2C) formed by the procedure described above may be deep enough so that further passes of the laser beam (103 in FIGS. 2A and 2B) relative to the solid material 102 is not needed. However, if the single cut line 208 is not deep enough, it can be further deepened, up to the entire thickness of the solid material 102, by repeating the procedure described above at different depths of the solid material 102. To deepen the cut line 208, the focus of the pulsed laser beam 103 is stepped deeper into the solid material 102. That is, the pulsed laser beam 103 is focused such that at a new target point deeper into the solid material 102 the pulsed laser beam has at least the minimum energy density required to ablate the solid material 102. With the focus of the pulsed laser beam 103 stepped deeper into the solid material, the focused laser beam 103 is again caused to trace the first path (200 in FIG. 2A), deepening the single cut line 208 along the first path as illustrated at 302 in FIG. 3A. The focused laser beam 103 then traces the second path, deepening the single cut line 208 along the second path as illustrated at 302 in FIG. 3B. The end result is a deeper single cut line 208.

The process of stepping the focus of the pulsed laser beam 103 deeper into the solid material 102 and tracing the first and second essentially parallel paths with the focused pulsed laser beam can be repeated until the single cut line 208 has the desired depth, which may or may not be equal to the thickness of the solid material 102. Thus, at each cut depth of the solid material 102, at least two essentially parallel cuts are made which partially or fully overlap to form a single cut line. For the same laser parameters, the two or more and overlapping cuts per cut depth, as illustrated in FIGS. 2A-2B and 3A-3B, create a wider kerf (K in FIG. 3B) in comparison to a single cut per cut depth. The wider kerf minimizes or prevents aberration and distortion of the pulsed laser beam as the pulsed laser beam 103 moves deeper into the solid material 102. With the multi-parallel-cut per cut depth method, the pulsed laser beam 103 can be as tightly focused as necessary to achieve the desired energy to ablate the solid material 102 while stepping deeper into the solid material 102. The method thus makes it possible to form a cut having a high aspect ratio and/or arbitrary shape in the solid material 102. A cut is considered to have a high aspect ratio if the cut depth to the kerf width is 5 or greater. In one embodiment, the single cut line has a kerf width less than 100 μm and a cut accuracy within 500 μm.

In one example, a sapphire sample was cut using a laser beam operating at 50 fs, 870 μJ pulses at a 1 kHz repetition rate and focused at 40 μm spot. The focused pulsed laser beam traversed the sample, that is, traced two essentially parallel paths, at a speed of 0.2 mm/s to make a roughly 40 μm deep trench (single cut line). To cut through a 0.5-mm thick sapphire sample, the sapphire sample was mounted on an x-y-z translation stage with minimum accuracy of 2 μm and repeatability greater than 1 μm. The pulsed laser beam was focused at the surface of the sample using a 10× objective lens to make the first set of essentially parallel cuts. The spacing between the essentially parallel paths was in a range from 20 to 50 μm. The pulsed laser beam was stepped successively deeper into the sample, and the essentially parallel cuts were made at each cut depth until the sample was separated. Using the same laser parameters, it was not possible to separate the sapphire sample with a single cut per cut depth.

In another example, a quarter of a circular sapphire wafer having a thickness of 0.5 mm and a diameter of 50 mm was separated using the multi-parallel-cut per cut depth method described above. The sample was separated using 50-fs pulses from a Ti:Sapphire laser with an operating wavelength near 800 nm. 850 μJ pulses were used, and the focus was translated across the solid material at 0.2 mm/s. The two essentially parallel cuts were separated by 40 μm. After each cut, the focus was stepped 20 μm deeper into the sample. It was not possible to separate the wafer using the scribe and cleave technique. Although one cut may be made along a crystallographic axis, the orthogonal cut was prohibited from being along another cleave plane.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of cutting a solid material using a pulsed laser, comprising:
providing a pulsed laser beam;
selecting a target point in the solid material;
focusing the pulsed laser beam on the solid material such that at the target point in the solid material the pulsed laser beam has at least the minimum energy density required to ablate the solid material; and
effecting relative motion of the pulsed laser beam with respect to the solid material such that the pulsed laser beam traces a first path to form a first scribe line in the solid material and then traces a second path to form a second scribe line in the solid material, wherein the first path and the second path are essentially parallel and the first and second scribe lines overlap to form a single cut line in the solid material.

2. The method of claim 1, further including moving the target point deeper into the solid material and repeating focusing the pulsed laser beam and effecting relative motion of the pulsed laser beam to deepen the single cut line.

3. The method of claim 2, further comprising repeating moving the target point, focusing the pulsed laser beam, and effecting relative motion of the pulsed laser beam until the single cut line reaches a desired depth in the solid material.

4. The method of claim 3, wherein the desired depth is equal to a thickness of the solid material.

5. The method of claim 3, wherein the desired depth is greater than 200 μm.

6. The method of claim 3, wherein the ratio of the desired depth to the kerf width of the single cut line is 5 or greater.

7. The method of claim 1, wherein the essentially parallel paths are linear.

8. The method of claim 1, wherein the essentially parallel paths are curvilinear.

9. The method of claim 1, wherein pulse duration of the pulsed laser beam is in a range from 10 femtoseconds to 200 picoseconds.

10. The method of claim 1, wherein the solid material is a large bandgap material.

11. The method of claim 1, wherein the solid material is a transparent material.

12. A system for cutting a solid material, comprising:
a laser device for providing a pulsed laser beam;
a support for mounting the solid material thereon; and
a mechanism for effecting relative motion of the pulsed laser beam with respect to the solid material such that the pulsed laser beam traces a first path to form a first scribe line in the solid material and then traces a second path to form a second scribe line in the solid material, wherein the first path and the second path are essentially parallel and the first and second scribe lines overlap to form a single cut line in the solid material.

13. The system of claim 12, further comprising an optical system which focuses the pulsed laser beam such that at a target point in the solid material the pulsed laser beam has at least the minimum energy density required to ablate the solid material.

14. The system of claim 12, further comprising a control apparatus which controls the mechanism to effect relative motion of the pulsed laser beam with respect to the solid material.

15. The system of claim 12, wherein the pulsed laser generates laser pulses with a duration in a range from 10 femtoseconds to 200 picoseconds.
